(19) United States
(12) Patent Application Publication
(10) Pub. No.: US 2014/0058958 A1
(43) Pub. Date: Feb. 27, 2014

(54) Method for Offering Lower Rent And Improved Service To Tenants In A Multi-Tenant Building that are Sharing a Data Center in the Multi-Tenant Building

(71) Applicant: Marc S. Billings, Miami, FL (US)

(72) Inventor: Marc S. Billings, Miami, FL (US)

(73) Assignee: DATA CENTERS WORLDWIDE, INC., Miami Beach, FL (US)

(21) Appl. No.: 13/890,230

(22) Filed: May 8, 2013

Related U.S. Application Data
(63) Continuation-in-part of application No. 12/380,795, filed on Mar. 4, 2009, now abandoned.

(51) Int. Cl. G06Q 30/06

(52) U.S. Cl. CPC G06Q 30/0645
USPC 705/307

(57) ABSTRACT

A common area data center for a tenant suite in large scale commercial office properties built in situ having a dedicated space, at least one computer module in the space and a self-sustaining cooling system to maintain a cooling temperature for the computer module consistent 24/7/365. This provides significant value in services and cost savings to both landlord and tenant. Each tenant can access greater levels of technology, security, and energy efficiency.

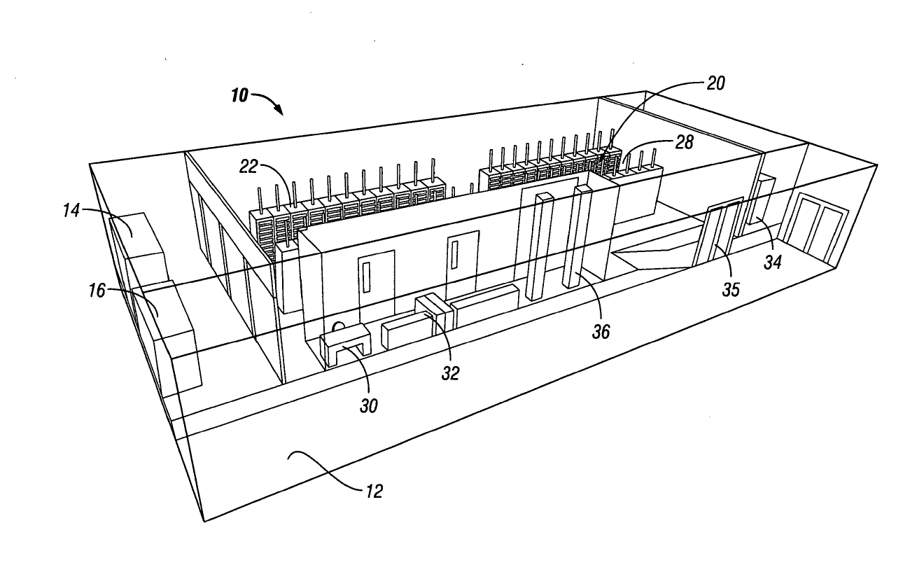

### CROSS-REFERENCE TO RELATED APPLICATIONS

This application is a continuation-in-part of application Ser. No. 12/380,795 filed Mar. 4, 2009. The contents of application Ser. No. 12/380,795 including all Declarations under Rule 1.132 are hereby incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to a building module for a shared data center facility appropriate for a multi-tenant office building which can be integrated in situ directly with the building cooling, power, fiber optics and security systems or as an option, can be provided and operated with external, self-contained systems.

2. Description of the Related Art

Data centers with modular components suitable for use with rack or shelf mount computer systems can be prepackaged as shown in U.S. Pat. No. 7,278,273 in self-contained, fixed unit packages. This has the disadvantage of not being able to be integrated within traditional commercial office building developments and not flexible enough to be integrated into a building cooling infrastructure, building power systems, and building fiber optics riser infrastructure. Additionally, prepackaged systems do not provide the level of access, level of multi-customer security, deployment flexibility in varied equipment installations and long term changes in integration options that may extend the lifetime of a commercial structure. Finally, the use of containers for integration into commercial office structures is impractical and wasteful of materials.

As stated in this patent, many of today's more complex computing systems such as computer server systems are designed for rack oriented housing to maintain operating and space efficiencies, having a number of removable electronics modules, such as electronics trays positioned and stacked relative to each other in a shelf-like manner within a frame or rack. The rack-mounted systems allow the arrangement of several electronics modules in a vertical orientation for efficiency of space. Each electronics module can be slid into and of the rack-mounting system. Each electronics module may correspond to a different and or each electronics module may hold one or more components of a server. Examples of electronics modules include modules for processing, storage such as random as memory (RAM), network interfaces and controllers, drives such as floppy disk drives, hard drives, compact (CD) drives, and digital video disk (DVD) drives, lid and serial ports, small computer systems interface (SCSI) bus controllers, video controllers, power supplies, and so forth.

In situ installation usually consists of a server farm housed in a data center such as a colocation and may include hundreds of racks that hold various types of computer modules or very small installations located within the user's leased office space within the commercial office building which house company specific computer modules. When the server racks are installed in the co location site the computing location is removed geographically from the actual computing location of the end users creating a disconnection of computing and use. When the server racks are installed within tenant's suite, the computing equipment is housed locally and therefore achieves higher performance, more convenience for maintenance and lower operating costs though the location is below the best standard of care in housing computing equipment. Each of these solutions presents unique barriers to cost, time and materials efficiencies that are remedied through the insertion of purpose built, integrated facilities within the commercial office property to serve the tenants of that property.

As an example, locating servers in a remote facility requires company information technology employees to drive or fly long distances to manage and maintain servers with a physical presence. This process creates time inefficiencies for change management of systems, time inefficiencies for employees required to travel to remote locations and energy loss for transportation requirements.

Also, the current system of tenants operating their own computer rooms within their tenant office suites presents significant shortcomings in data center services, energy efficiencies and operational efficiencies. Due to limitations in economies of scale, tenants are unable to access core data center requirements such as generator power, 24/7 cooling flow, redundant fiber optic access, scalable space requirements, centralized battery backup systems, and non-data center fire suppression without significant cost requirements. Therefore, tenants are typically dependent on substandard computer rooms to house their information. The substandard housing of computer equipment limits future technology innovation by presenting a barrier of dependency on the systems based on reliability concerns. Additionally, due to the lack of economies of scale of the facility construction, the ability to integrate with the central building cooling systems is limited creating inefficient cooling designs. This inefficient cooling design increases overall building and larger scale aggregate society energy usage placing the economy at a disadvantage and driving costs higher. A direct effect of the inefficiency is the increased costs of electricity within the commercial property causing price increases and decreasing demand and, therefore, utilization. Additionally, due to economies of scale, management and maintenance of small facilities place an undue burden of management on tenants and landlords creating a cost and performance inefficiency. Centralization of services places trained professionals in charge of facility management, allowing Information Technology specialists the ability to focus on Information Technology tasks.

Thus, neither in-suite facilities nor prepackaged or offsite colocation data centers are cost efficient or user friendly.

### BRIEF SUMMARY OF THE INVENTION

An object of the invention is to provide a method for offering lower rent and improved service to tenants in a multi-tenant building that are sharing a data center in the multi-tenant building that overcomes the disadvantages of the methods of this general type and of the prior art.

With the foregoing and other objects in view there is provided, in accordance with the invention, a

This invention discloses a centralized common area data center solution for tenants of multi -tenant commercial office properties which provides significant value in services and cost savings to both landlord and tenant. The centralized modular facility design provides increased access to high technology services for tenants of the properties while delivering significantly decreased energy and materials utilization for the landlord. Furthermore, tenants and related parties receive significantly improved operational efficiencies greater than individual tenant suite facilities without having to resort to offsite colocation all the while providing a base of innovative resources within the property for other future products and services development and delivery. The offering and provision of a customized module in situ, rather than a prepackaged module creates an integrated solution suitable for the unique requirements of commercial office construction.

Modular data centers with modular components suitable for use with rack or shelf mount computing systems, for example, are disclosed and it should be appreciated that the present invention can be implemented in numerous ways, including as a process, an apparatus, a system, a device, or a method. Several inventive embodiments of the present invention are described below.

According to a sample embodiment, a modular data center in accordance with carrying out the invention generally includes a reduced scale modular room including, for example, a compressor, a condensing coil, heat exchanger, pumps, controls, and/or motors for a temperature control system. The modular data center may additionally include evaporative, compressed fluid, or other suitable cooling system in communication with modular computing systems mounted within rack and/or shelf mounting structures and each mounting structure may be enclosed in an enclosure with an access door, each enclosure being associated with a master temperature control subsystem. Each temperature control subsystem may include a blower and an evaporator coil, the blower including a blower motor and blower blades container, respectively. The enclosure also may define a delivery plenum and a return plenum in thermal communication with the corresponding temperature control subsystem and with the computing systems contained within the corresponding enclosure. This enables 24/7/365 cooling to be provided, if required, in addition to the building cooling system. The room may also be provided with its own generator or power source as a backup system, fiber optic interconnection, internet service provisioning, access control system, cabling riser management interconnection system, remote systems monitoring, and fire suppression system. Finally, the data center room module also can be outfitted with a technician work area, an equipment staging area, a cross connect room or any combination thereof.

The benefits are manifold. From the tenant standpoint, there is provided an increase in system reliability, increased environmental stability, increased bandwidth, decreased maintenance requirements, 24/7/365 days monitoring, increased security, reduced time to occupy space and reduced capital cost to build out. From the landlord standpoint, the module is provided in move in ready condition, reduces capital costs to occupy new tenants, reduces material requirements to complete the housing of tenant computer systems, improves ability to upgrade future tenant requirements in a consolidated location, reduces computer room for maintenance expenses, reduces energy consumption required to cool computer systems within the building, and balances the cooling requirement of human loads throughout the balance of the property, enabling more efficient cooling system design. These and other features and advantages of the present invention will be presented in more detail in the following detailed description and the accompanying figures which illustrate by way of example the principles of the invention.

In accordance with the objects of the invention, a method for offering lower rent and improved service to tenants in a multi-tenant building that are sharing a data center in the multi-tenant building is provided. The first step of the method involves providing a multi-tenant building housing a first office, a second office, and a computing-module room. The first office is leased to a first tenant. The second office is leased to a second tenant. The computing-module room houses a computer of the first tenant and a computer of the second tenant. The next step involves calculating a rent for the first office where the rent is lower than a rent of the first office plus a rent of a notional data center rented exclusively to the first tenant. The notional data center could be based on the office space that would be required to house the computer equipment of the first tenant that is instead being housed in the data module. The last step involves charging the rent to the first tenant.

A further object of the invention is to bring a greater total rent for the building to the landlord. To do this, the method provides for charging a rent for a second tenant, where the rent is lower than a rent of the second office plus a rent of a notional data center to be used exclusively by the second tenant. The next step is charging a first further rent to the first tenant for sharing the data-module room. The next step is charging a second further rent to the second tenant for sharing the data-module room. The sum of the first further rent and the second further rent should be set to be greater than a potential rent of the data-module room to a notional tenant, the notional tenant not using the data-module room as a data-module room.

The method can be applied to apportion the cost of additional services to the data module that result in lower expenses to the tenants but greater rents to the landlord. Additional services include 24/7 HVAC service, a dedicated HVAC system for the data module, access control, fire suppression systems, and monitoring (i.e. security) to the data module.

Other features that are considered as characteristic for the invention are set forth in the appended claims.

Although the invention is illustrated and described herein as embodied in a m method for offering lower rent and improved service to tenants in a multi-tenant building that are sharing a data center in the multi-tenant building the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

The sole FIGURE is a diagrammatic perspective view of a modular data center according to the invention.

### DETAILED DESCRIPTION OF THE INVENTION

A data center facility for a multi tenant commercial office building suitable for use with rack or shelf mount computing systems, is disclosed. The sole FIGURE is a perspective view of an illustrative implementation of a data center facility 10 suitable for use with rack and/or shelf mount computing systems. The data center facility 10 may be constructed in situ in dedicated space 12 provided in multitenant commercial office building and includes at least one computing module 20 each with multiple computing units on shelves or racks 22. In the example shown in the sole FIGURE, the data center 10 as is also provided with a power and cooling equipment 14, 16 containing power generation equipment and cooling equipment (e.g., compressor(s), heat exchangers, circulation pumps, controls, etc.), network interconnection points, respectively.

Blower motors (not shown) may extend from the rack or be incorporated within the rack designs 22 to expel and recirculate warm air to produce cooling within the facility, depending upon available space. The racks or shelves 22 may be arranged so as to provide a walkway 28 for service access and/or to facilitate temperature and/or humidity control. In addition, a workbench 30 can optionally be provided, along with an equipment staging area 32. An access control based security area 34 is also provided in the facility 10 adjacent an entry door or multiple doors 35 along with a cross connect room 36. Door 35 is provided adjacent the security area 34 to provide access for service personnel on-site at the data center facility.

On site, the modular components are interconnected and/or connected to external resources such as cooling equipment, electricity, natural gas, fuel cell power generation, solar power generation, water; and/or Internet connections to form the completed data center. For offsite servicing and/or maintenance, components of the respective modular facility can be disconnected from other modular component(s) and/or various resource connections and transported to a servicing facility, e.g., the factory that built the module or a separate maintenance facility, and then returned to the original. Alternatively, a new replacement component can be brought to the site and the component being replaced can be disconnected and transported to a servicing facility, e.g., the build facility, and optionally placed back into service at the same or a different site. In particular, as each component reaches the end of its service life, the component may be disconnected from the remainder of the modular data center and removed from the site and a replacement modular component may be installed as a replacement. Similarly, as each rack/shelf and/or computing unit within the computing module reaches the end of its service life, that rack/shelf and/or computing unit may be disconnected from the remainder of the computing module and removed from the data center site and a replacement rack/shelf and/or computing unit may be installed as a replacement. Such a modular-method of servicing the modular data center also takes advantage of the use of modular components.

Furthermore, the modular data center facilitates ease of deployment and therefore widespread deployment of facilities in commercial office properties creates an environment of increased efficiencies and innovation. The design of the facility allows for reduced material requirements and increased performance for tenant computing requirements and thus more economically feasible. In one implementation, a modular system may reduce the cost of moving by approximately 60 to 80% to provide more viable options even within the nominal life of a module and decrease cooling costs for data center users by 80%.

The facility is also provided with its own systems that are operational 24/7/365 even if the building systems are unavailable or shut down for maintenance. For example, the building cooling system is usually operational between 7 AM and 9 PM; but it may be necessary to cool the computer modules outside of these hours or in a more efficient fashion. The data facility having its own integrated systems can be operated as desired. Further, it may enable the tenant to negotiate a lease wherein after hour power and cooling is not required wherein costs over the term of the tenant's lease can be capitalized or reduced. The chart below shows the advantages and benefits of the disclosed tenant data center facility:

| | Tenant | Tenant |
|---|---|---|
| | Suite | Data Center |
| Access Control | X | X |
| Security Cameras | X | X |
| Primary Electric | X | X |
| Daytime HVAC | X | X |
| Generator Backup Power | | X |
| Redundant HVAC | | X |
| 24/7 HVAC | | X |
| Data Center Fire Suppression | | X |
| Redundant Fiber Optic Network | | X |
| Increase/Decrease Footprint | | X |
| Energy Efficient | | X |
| 24/7 Systems Monitoring | | X |

To reiterate, commercial office properties are served via large scale water chiller and cooling towers. These systems are expensive to run and operate as part of an office lease only during business hours, typically 7 am to 8 pm. Once these systems turn off, the tenant is required to either pay for overtime air conditioning ($30-$50/hr) or provide secondary air conditioning systems within the tenant space to serve the computer room. Central chiller systems also require a consistent supply of water from city systems; therefore systems are shut down during hurricane/emergency scenarios to prevent system failure.

The module data centers of the present invention operate closed loop 24/7/365 redundant cooling systems separate from building cooling systems providing the consistent cooling design required for the tenant's data systems.

Generator space is extremely limited in the commercial office environment. Property owners may be required to have generator power for life safety systems but this power is difficult and expensive to provide elsewhere in the property. Locations to place generators are extremely limited, are expensive and require regular maintenance. The module data center as disclosed in the present invention has consolidated otherwise disparate computer systems enabling the cost effective delivery generator backup power as part of the facility for all customers. This consolidation is also effective for the future incorporation of non fuel or non electrical based power generation such as solar, chemical or geothermal.

Consolidation of disparate systems into the module facility enables fire suppression systems of a higher caliber to be installed within the facility. Water is the overwhelming choice of commercial office properties for fire suppression. Office fire systems are designed to release in zones making it difficult to isolate computer rooms from a general release. With a module data center as disclosed herein, computer and human safe non-water based fire suppression systems can be provided.

Electrical consumption is both an issue to reduce carbon footprint as well as a direct financial issue for commercial properties Landlords and tenants. Data Center requirements are the largest per square foot user of energy in a commercial property. The data center of the present invention delivers an extremely high ratio of power to cooling resulting in reduction of energy requirements up to 80% over traditional commercial office computer room cooling designs. Energy efficiency will therefore drive lower costs for all businesses.

Not only does the tenant data center of the instant invention result in reduced network costs and energy use, but decreased operating expenses, for a one time relatively nominal expense.

While the preferred embodiments of the present invention are described and illustrated herein, it will be appreciated that they are merely illustrative and that modifications can be made without departing from the spirit and scope of the invention. Thus, the invention is intended to be defined only in terms of the following claims.

What is claimed is:

1. A method for offering lower rent and improved service to tenants in a multi-tenant building that are sharing a data center in the multi-tenant building, the method which comprises:
providing a multi-tenant building housing a first office, a second office, and a computing-module room, said first office being leased to a first tenant, said second office being leased to a second tenant, said computing-module room housing a computer of said first tenant and a computer of said second tenant;
calculating a rent for said first office, said rent being lower than a rent of said first office plus a rent of a notional data center rented exclusively to said first tenant; and
charging said rent to said first tenant.

2. The method according to claim 1, which further comprises:
charging a rent for said second tenant, said rent being lower than a rent of said second office plus a rent of a notional data center to be used exclusively by said second tenant;
charging a first further rent to said first tenant for sharing said data-module room; and
charging a second further rent to said second tenant for sharing said data-module room;
a sum of said first further rent and said second further rent being greater than a potential rent of said data-module room to a notional tenant, said notional tenant not using said data-module room as a data-module room.

3. The method according to claim 2, wherein said potential rent to be paid by said notional tenant for said data-module room is greater than a rent to be charged for said notional tenant when not using said data-module room as a data-module room.

4. The method according to claim 1, which further comprises:
including a heating, ventilating, and air-conditioner system for controlling a temperature within said first office, controlling a temperature within said second office, and controlling a temperature within said computing-module;
controlling the temperature within said first office with said system at a first set point for only a portion of each day;
controlling the temperature of said second office with said system at a second set point for only for a portion of each day;
said heating, ventilating, and air-conditioner system controlling the temperature of said computing-module with said system at a third set point for an entirety of each day; and
basing said rent to said first tenant at least in part on an electrical bill for controlling said temperature of said first office and for controlling said temperature of said computing module;
basing said rent to said second tenant at least in part on an electrical bill for controlling said temperature of said second office and for controlling said temperature of said computing module; and
charging said first tenant less than an entire portion of said expense for controlling said temperature of said computing module.

5. The method according to claim 4, which further comprises:
providing a further heating, ventilating, and air-conditioner system for controlling a temperature within said computing-module room, said further system not controlling the temperature within said first office and not controlling the temperature in said second office;
controlling a work-time temperature of said first office and said second office only for a portion of each day with said system;
controlling the temperature of said computing-module with said further system for an entirety of each day;
charging said first tenant for a portion of an expense of said further system; and
charging said second tenant for a portion of the expense of said further system.

6. The method according to claim 4, which further comprises:
providing a backup heating, ventilating, and air-conditioner system for controlling the temperature of said computing-module room when said heating, ventilating, and air-conditioner system fails to control the temperature of said computing-module room;
charging a portion of an expense of said backup system to said first tenant; and
charging a portion of the expense of said backup system to said second tenant.

7. The method according to claim 1, which further comprises:
providing a data-center fire suppression system connected to said computing-module room and configured to suppress fires in said computing-module room, said data-center fire suppression system not being configured to suppress a fire in at least one of said first office and said second office;
charging said first tenant a portion of an expense for said data-center fire suppression system; and
charging said second tenant a portion of the expense for said data-center fire suppression system.

8. The method according to claim 1, which further comprises:
providing a backup power supply connected to said computer-module room for providing electricity to said computing-module room when a primary power supply fails, said backup power supply not being configured to provide electricity to at least one of said first office and said second office;
charging said first tenant a portion of an expense for said backup power supply; and
charging said second tenant a portion of the expense for said backup power supply.

9. The method according to claim 1, which further comprises:
providing said computing-module room with an access control based security area for providing access for service personnel to said computing-module room;
charging said first tenant a portion of an expense for said access control based security area; and
charging said second tenant a portion of the expense for said access control based security area.

10. The method according to claim 1, which further comprises:
monitoring said first office for less than an entire day;
monitoring said computing-module room for the entire day; and
charging said first tenant a portion of an expense for monitoring said computing module.
